(19) United States
(12) Patent Application Publication
(10) Pub. No.: US 2005/0011996 A1
(43) Pub. Date: Jan. 20, 2005

(54) Fastener technology

(76) Inventor: Ralph D. Geater, Osceola, WI (US)

Correspondence Address: JOEL D. SKINNER, JR.;SKINNER AND ASSOCIATES, 212 COMMERCIAL ST., HUDSON, WI, 54016, US

(21) Appl. No.: 10/622,960

(22) Filed: Jul. 18, 2003

(51) Int. Cl. F16B 15/00

(52) U.S. Cl. 248/71; 248/74.2; 248/74.4; 248/316.1

(57) ABSTRACT

A system for fastening an electrical cable to a wall stud or structural member. The system includes a rectilinear frame with first and second ends and a predetermined length. A leg is communicatively connected to the frame at the first end, the leg being for coupling contact with the wall stud, the leg having an aperture disposed at a predetermined location thereon. The system further includes a fastener such as a nail and a screw, the fastener being adapted for driving into the wall stud through the leg aperture. A lock member is connected to the frame at a predetermined location, the lock member having a mating notch. A flexible arm is connected to the frame at the second end, the arm having a curvilinear configuration defining a substantially cylindrical passage with open ends adapted to receive the electrical cable in use, the arm having a free end with a mating notch which is releasibly couplable to the mating notch of the lock member.

### BACKGROUND

1. Field

The present invention relates, generally, to fasteners, clamps and holders, and methods of manufacture and use therefor. More particularly, the invention relates to a device for engaging a cable and fastening it to a structural member such as a wall stud. A method of use for the fastener device and a method of making the fastener are also disclosed The fastener and methods of this invention are particularly useful for electrical wiring of commercial buildings. The techniques of the invention can also be used in other fields such as electrical wiring of residential buildings, low voltage wiring, wiring of various craft, plumbing and the like.

2. Background Information

Existing technology, in general, includes apparatus and/or methods for fastening wires. This technology is believed to have significant limitations and shortcomings, including but not limited to difficulties of installation and problems with placement of electrical wires in too close proximity to structural members.

Existing members are difficult to use and install. Some fasteners are very small. This makes them difficult to pick up and to firmly grasp, especially when holding the fastener at the time of nailing or screwing to a structural member, such as a wall stud. This can also require that the held cable is placed directly on or in very close proximity to the stud. Placement of the cable on or near the stud exposes the cable to damage when sheet rock or other wall material, or other mechanical structures (such as other wiring, plumbing, or HVAC elements) are attached to the stud. Sheet rock in particular is a problem because fasteners, typically screws, are driven into the studs without the installer being able to visually appreciate the stud and any wiring fixed thereto. Also, installers tend to work extremely fast and often without great care. Screws which puncture wires can cause complete failure of electrical systems or can degrade their performance. Diagnosing problems of this nature is particularly problematic because the damage is covered up by the wall.

Some fasteners must engage the cable to be held at the same time the fastener is being secured to the stud. This slows down the securement process. This can be a costly problem in large building projects.

Some fasteners cannot disengage cable when necessary for alignment, adjustment, or troubleshooting.

For these and other reasons, a need exists for the present invention.

All U.S. patents and patent applications, and all other published documents mentioned anywhere in this application are hereby incorporated by reference in their entirety.

### BRIEF SUMMARY

The present invention provides an apparatus or device for engaging or clamping and fastening or holding articles such as cables and methods of use and manufacture therefor, which is practical, reliable, accurate and efficient, and which is believed to fulfil a need and to constitute an improvement over the background technology.

The fastener and methods of this invention are particularly useful for electrical wiring of commercial buildings. The techniques of the invention can also be used in other fields such as electrical wiring of residential buildings, low voltage wiring (such as telephone, computer network, audiovisual, and the like) wiring of various craft (such as motor vehicles, watercraft, and aircraft), plumbing and the like.

In one aspect, the invention provides a device comprising:
a. a frame,
b. a leg communicatively connected to the frame, the leg being for coupling contact with an external base object;
c. an arm connected to the frame, the arm defining a passage in which an article is disposed.

In another aspect, the invention provides a cable fastening device comprising:
a. a frame with first and second ends,
b. a leg communicatively connected to the frame at the first end, the leg being for coupling contact with an external base object;
c. a lock member connected to the frame at a predetermined location; and
d. a flexible arm connected to the frame at the second end, the arm having a rectilinear configuration defining a substantially cylindrical passage with open ends adapted for receiving the cable, the arm having a free end which is releasibly couplable to the lock member.

In a further aspect, the invention provides a system for fastening an electrical cable to a wall stud or the like comprising:
a. a rectilinear frame with first and second ends and a predetermined length,
b. a leg communicatively connected to the frame at the first end, the leg being for coupling contact with the wall stud, the leg having an aperture disposed at a predetermined location thereon;
c. a fastener selected from the group of fasteners consisting of a nail and a screw, the fastener being adapted for driving into the wall stud through the leg aperture;
e. a lock member connected to the frame at a predetermined location, the lock member having a mating notch; and
f. a flexible arm connected to the frame at the second end, the arm having a curvilinear configuration defining a substantially cylindrical passage with open ends adapted to receive the electrical cable in use, the arm having a free end with a mating notch which is releasibly couplable to the mating notch of the lock member.

The features, advantages, benefits and objects of the invention will become clear to those skilled in the art by reference to the following description, claims and drawings.

### BRIEF DESCRIPTION OF THE SEVERAL VIEWS OF THE DRAWING

FIG. 1 is a perspective view of the cable fastener of the present invention.

FIG. 2 is a side or elevation view of the cable fastener operatively disposed and securing a cable to a structural member, such as a wall stud.

FIG. 3 is a plan or top view, partially in crossection, of an operatively disposed cable fastener.

FIG. 4 is a front view of the cable fastener.

FIG. 5 is a top view of the cable fastener.

FIG. 6 is a back view of the cable fastener.

FIG. 7 is and end view of the cable fastener.

FIG. 8 is an opposite end view of the cable fastener.

FIG. 9 is an elevation view of a wall frame with a plurality of cable fasteners of the present invention operatively disposed.

### DETAILED DESCRIPTION

This application shows and describes one embodiment of the present invention, generally indicated by the reference numeral 10. The embodiment of the invention is intended to be illustrative and not to be exhaustive or limit the invention to the exact forms disclosed. The embodiment is chosen and described so that persons skilled in the art will be able to understand the invention and the manner and process of making and using it.

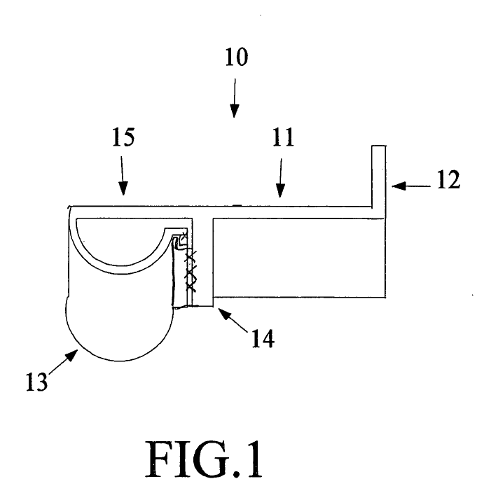

Referring to FIG. 1 a preferred embodiment of the fastener 10 of the present invention is shown. The fastener 10 engages, clamps and fastens articles such as cables to external structures. The fastener 10 is particularly useful for fastening electrical cables to wall studs in new and renovated buildings. The fastener 10 is particularly useful for commercial building applications. The fastener 10 can also be used in other fields such as electrical wiring of residential buildings, low voltage wiring (such as telephone, computer network, audiovisual, and the like) wiring of various craft (such as motor vehicles, watercraft, and aircraft), plumbing and the like. The fastener 10 is compliant with the National Electrical Code, and NEC 300.4, 300.30, and 334.30 in particular.

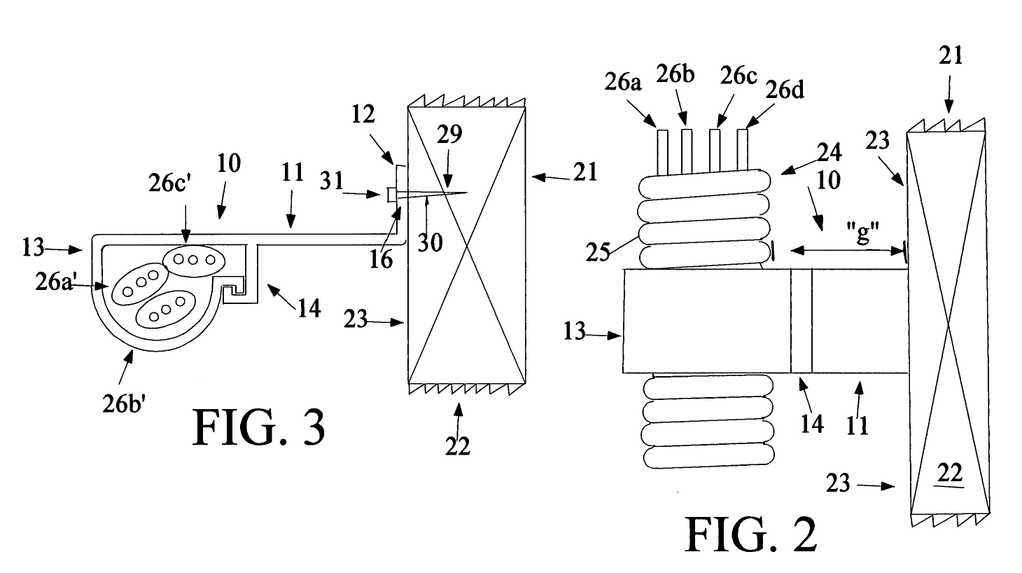

The fastener 10 basically includes a frame 11, a leg 12, an arm 13 and a lock member 14. Referring also to FIGS. 2 and 3, fastener 10 is connectable to a structural member 21, in this case a wall stud, of a building or the like. The arm 13 is movable to permit placing an article such as a cable 24 through passage 15. In this manner, the cable 24, or a plurality of cables 26a′-c′, are coupled to the stud 21 and releasibly held in place a predetermined distance therefrom.

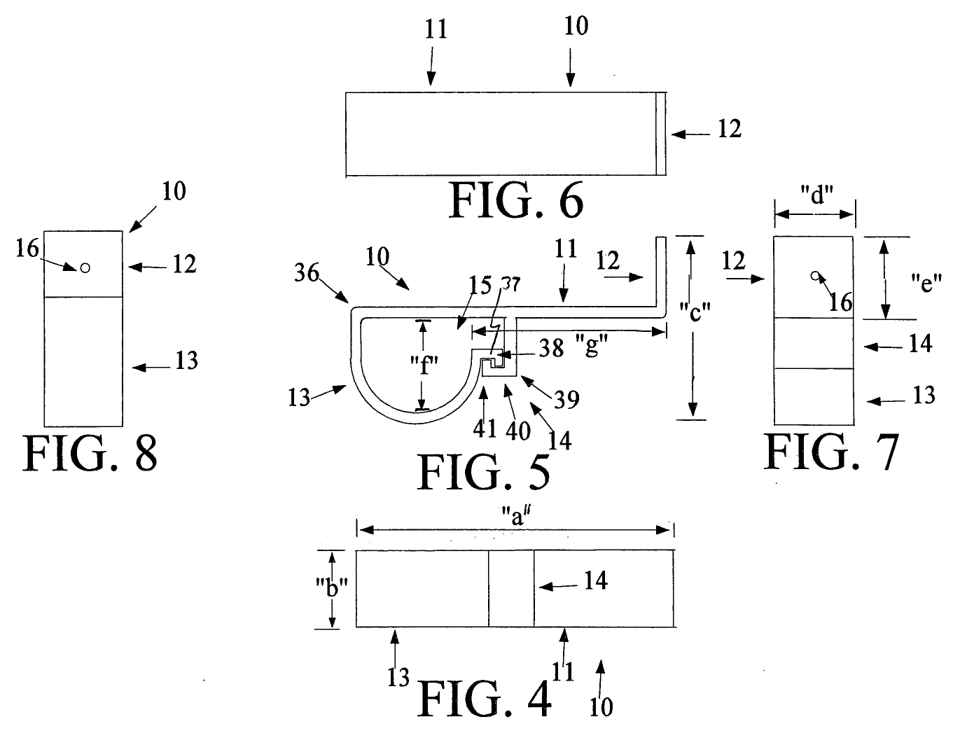

Referring also to FIGS. 4-7, the frame 11 of the fastener 10 has an rectilinear, slightly elongated, preferably flat and smooth configuration with a first or proximal end and a second or distal end 36. The frame 11 provides a base structure for the remaining elements of the fastener 10 and in particular, provides a means of spacing the cable or other fastened article from the structural building member other base. Leg 12 is connected to the first (proximal) end of the frame 11 and preferably is disposed at a right angle thereto. The leg 12 is for contact with a structural building member or other base. Aperture 16 is preferably centrally disposed in leg 12 and provides a convenient means of centering and disposing a fastener or anchor through the leg 12 and into the structural member. Arm 13 is connected to the opposite, second (distal) end 36 of the frame 11. The arm 13 preferably has a substantially curvilinear inside configuration. This configuration defines a circumferential dimension of cylindrical cable passage 15. The arm 13 provides a means of engaging and holding a cable or other article. The opposite end of the arm 13 is preferably configured to releasibly mate with lock member 14. The arm 13 has a bracket member 37 that depends from the end of the arm 13 at a right angle. A lip member 38 depends from the bracket member 37 at a right angle thereto to form a shallow coupling notch of a predetermined dimension. Lock member 14 includes a post 39 which is connected to and extends from the frame 11. A bracket 40 depends from the end of the post 39, at a right angle thereto. A lip 41 depends from the bracket 39 to form a coupling notch. The locking member 14 coupling notch releasibly mates with the arm member 13 coupling notch.

The fastener 10 is preferably constructed of a polymeric material such as polypropylene. The fastener material is rigid enough to provide structural stability and hold a cable to a stud 21 or the like. The material is flexible enough to permit flexing of the arm 13 during cable placement and locking. Also, it should be pliable enough so that the frame 11 flexes if any part of the fastener 10 is impacted by a nail or screw, for example one which is intended to be driven into the stud 21 but which misses, whereby the fastener avoids penetration of the held cable by such nail or screw. The material should be pliable in cold weather (about 32 degrees F.) Alternative polymers include styrene. Further in the alternative, the fastener 10 may be constructed of a metal provided that the edges of all surfaces are rounded off or other wise smoothed.

The size of the fastener 10 may be selected to accommodate different sizes of cables and cable connection applications. The fastener 10 illustrated is capable of connecting one or more wires or cables (corrugated round (AC) 26 or flat (NM) 26a′-c′) of sizes up to approximately #4/2 gauge. As such, the fastener 10 preferably has a length (“a”) of 3 inches, a width (“b”) of ¾ inch, and a height (“c”) of 2 inches as is best shown in FIGS. 4 and 5. As is best shown in FIG. 7, leg 12 preferably has a height (“d”) of ¾ inch and a width (“e”) of ¾ inch to provide an adequate mating surface with respect to the stud. As is best shown in FIG. 5, the major diameter (“f”) of the arm is approximately 1 inch maximum. Importantly, the distance from the passage 15 to the stud 21 (“g”) is 1⅝ inches to provided adequate separation of the cable from the stud 21 (particulary the center of the stud 21, as is also best shown in FIG. 5. This minimizes the potential for sharp objects such as screws or nails intended to be driven into a stud or other structural member (often out of sight of the worker due to the presence of gypsum board or other wall forming material) to which the fastener 10 is attached, or tools used around the structural member, from impacting and penetrating the held wires or cables. In the preferred embodiment, the structural elements of the fastener 10 are constructed in a unitary device. A preferred material thickness is ⅛ inch. The dimensions described above may be modified, preferably proportionally, to construct fasteners for securing smaller or larger cables.

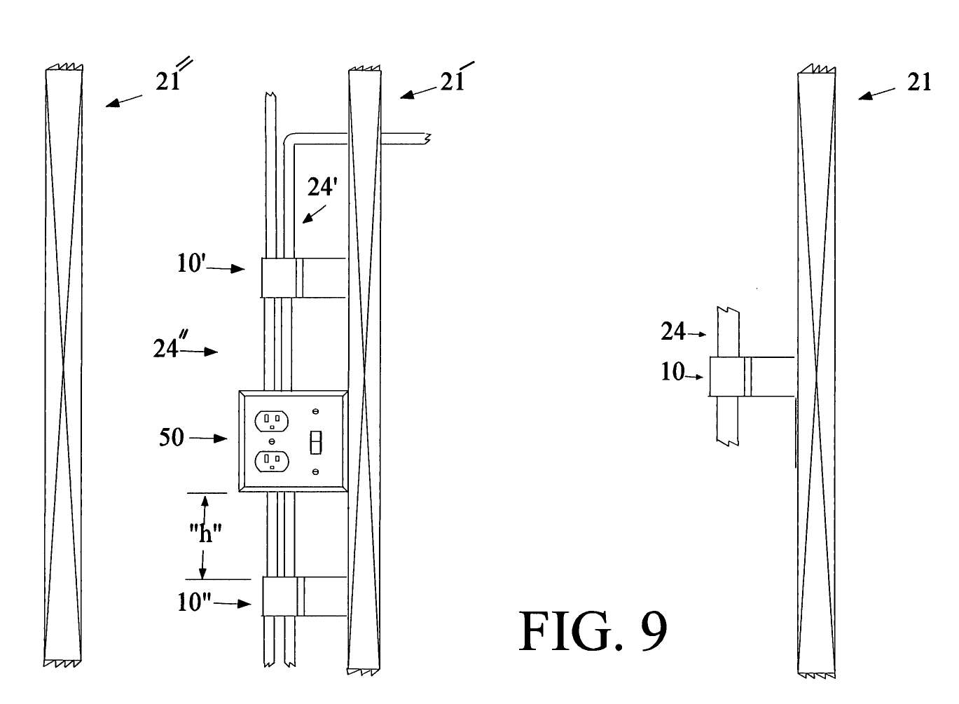

Referring again to FIGS. 2 and 3, in use, the fastener 10 is connectable to a structural member 21, in this case a wall stud, of a building or the like. Wall stud 21 is shown as a solid wood member. However, it is within the purview of this invention that the fastener 10 may be connected to studs constructed of metal or other materials and to other structural members such as conduits, pipes, walls, blocks, slabs, bricks, fixtures, furnishings, earth, and the like. The fastener 10 is grasped by the installer and the leg 12 is placed in contact with the stud 21. The leg 12 is shown abutting the side surface of a stud (which is shown as the 1¾ inch width side of a standard 2×4, but which may be a 2×6 or other size member), but the fastener may be attached to the front or face surface 22 of the stud 21 depending upon the cabling application. A secondary fastener such as a nail 29 is driven through aperture 16 until the shaft 30 of the nail 29 is fully inserted into the stud 21 and the head 31 contacts the leg 12. Alternative secondary fasteners 29 may be used such as a screw, bolt, adhesive, magnet or the like may be used. Referring to FIG. 9, a plurality of fasteners 10, 10′, 10″ . . . may be secured to the stud 21, neighboring studs 21′, 21″ . . . or other building elements, preferably aligned with one another, to provide a desired cable 24, 24′, 24″ . . . routes and configurations. The fastener 10 is useful in connection with installations of utility boxes 50 and other electrical system components. The arm 13 of the fastener 10 is depressed disengage arm lip 38 from bracket lip 41. Arm 13 is flexed away from frame 11 to permit placing cable 24 fully into passage 15. Next, arm 13 is released and moves towards frame 11 via a spring-like action. . One or more cables 24, lines or the like are placed in the passage 15. Arm 13 is depressed to engage arm lip 38 with bracket lip 41. In this manner, the cable 24 is locked in place in passage 15 and coupled to the stud 21. The cable 24 can be removed from the fastener 10 by again depressing the arm 13 to unlock the cable. Although the fastener 10 is shown providing a vertically aligned cable path 15, the fastener 10 may be arranged to orient the path 15 horizontally or at any angle with respect to earth.

Cable 24 is shown in FIG. 2 as common ROMEX type cable comprising a metallic outer jacket 25, and a plurality of internal wires 26a-d, each having a wire conductor 28 surrounded by insulation 27. However, other types of cables, wires, or conductors, including non-corrogated and flat structures, or other articles in general, may be used with the fastener such as flat cables 26a′-c″ in FIG. 3. Further, although the apparatus and method have been described in connection with the field of electrical wiring, it can readily be appreciated that it is not limited solely to such field, and can be used in other fields including, but not limited to plumbing, HVAC.

The fastener 10 of the present invention is preferably constructed by an extrusion process, but it may be made by an injection molding process.

The descriptions above and the accompanying drawings should be interpreted in the illustrative and not the limited sense. While the invention has been disclosed in connection with an embodiment or embodiments thereof, it should be understood by those skilled in the art that there may be other embodiments which fall within the scope of the invention as defined by the claims. Where a claim, if any, is expressed as a means or step for performing a specified function it is intended that such claim be construed to cover the corresponding structure, material, or acts described in the specification and equivalents thereof, including both structural equivalents and equivalent structures, material-based equivalents and equivalent materials, and act-based equivalents and equivalent acts.

1. A device for fastening electrical wires to a wall stud, comprising:
a. a frame having a predetermined length with first and second ends,
b. a planar leg communicatively connected to the frame, the leg having an aperture adapted to receive a screw or nail for coupling contact with the wall stud, the leg being disposed near the first end of the frame and extending from the frame at an angle thereto;
c. an arm disposed near the second end of the frame, the arm having a first end which is pivotally connected to the frame and a second end which is releasably connectable to the frame, the arm defining an openable and closeable passage adapted for grasping at least one electrical wire whereby in operation the passage is disposed a distance away from a wall stud to hold the electrical wire substantially away from the wall stud.

2. The device of claim 1, wherein the frame, leg and arm are constructed of a unitary material.

3. The device of claim 2, wherein the unitary material is plastic.

4. (Canceled).

5. (Canceled).

6. The device of claim 1, further comprising means to connect the leg to an external base object.

7. The device of claim 6, wherein the means to connect is selected from the group of connectors consisting of a nail, a screw, and adhesive.

8. The device of claim 1, further comprising an aperture disposed at a predetermined location in the leg for mating connection with a screw or nail.

9. (Canceled).

10. (Canceled).

11. The device of claim 10, wherein the arm has a curvilinear configuration.

12. The device of claim 11, wherein the arm is flexible.

13. The device of claim 11, wherein the passage has a cylindrical configuration with open ends through which the at least one electrical wire is disposed.

14. The device of claim 1, further comprising a lock member connected to the frame, and wherein the second end of the arm has a locking end which releasably mates with the lock member to open and close the passage for grasping the electrical wire.

15. The device of claim 14, wherein the lock member and locking end have complementary mating notches.

16. (Canceled).

17. (Canceled).

18. (Canceled).

19. An electrical cable fastening device for securely fastening electrical cable to a wide face of a wall stud, comprising:
a. a frame with first and second ends and a predetermined length,
b. a planar leg communicatively connected to the frame at the first end of the frame, the leg extending from the first end of the frame approximately at a right angle to the frame, the leg having an aperture adapted to receive a screw or nail for flat coupling contact with and against the wide face of the wall stud;
c. a lock member connected to the frame at a predetermined location; and
d. a flexible arm connected to the frame at the second end of the frame, the arm having first and second ends and a curvilinear configuration defining a substantially cylindrical passage with open ends adapted for receiving the cable, the first end of the arm being pivotally connected near the second end of the frame, the second end of the arm being releasably couplable to the lock member, whereby in operation the passage is adapted to be disposed approximately 1⅝ inches away from the wide face of the wall stud to maintain the cable a safe distance away from sharp fasteners intended to penetrate a narrow face of the wall stud.

20. A cable fastener for securely fastening an electrical cable to a wide face of a wall stud in preparation for wall board covering of a narrow face of the wall stud, comprising:
a. a rectilinear planar frame with first and second ends, first and second sides, and a predetermined length,
b. a rectilinear planar leg communicatively connected to the frame at the first end and extending outwardly at a right angle therefrom towards the first side of the frame, the leg being adapted for flat coupling contact with and against the wide face of the wall stud, the leg having a flat area with an aperture disposed centrally in the flat area adapted for connection with a screw or nail penetrating into the wall stud;
c. a lock member connected to the frame at a predetermined location on the second side of the frame, the lock member having a mating notch; and
d. a flexible arm connected to the frame at the second end and on the second side, the arm having first and second ends and a curvilinear configuration defining a substantially cylindrical passage with open ends adapted to receive the electrical cable in use, the cylindrical passage being oriented parallel with the plane of the leg, the first end of the arm being pivotally connected near the second end of the frame, the second end of the arm having a mating notch which is releasably couplable to the mating notch of the lock member, whereby in operation, the passage is adapted to be disposed approximately 1⅝ inches away from the wide face of the wall stud to maintain the cable a safe distance away from sharp nail or screw fastener intended to be penetrate wall board covering and a narrow face of the wall stud, and the passage orients the fastened cable substantially parallel with the wall stud.
